(19) United States
(12) Patent Application Publication
(10) Pub. No.: US 2014/0278964 A1
(43) Pub. Date: Sep. 18, 2014

(54) POST-CHECKOUT OFFER SYSTEMS AND RELATED METHODS

(71) Applicant: UNITED PARCEL SERVICE OF AMERICA, INC., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/210,813

(22) Filed: Mar. 14, 2014

Related U.S. Application Data
(60) Provisional application No. 61/786,052, filed on Mar. 14, 2013.

(51) Int. Cl. G06Q 30/02; G06Q 50/00

(52) U.S. Cl. CPC G06Q 30/0253; G06Q 30/0255; G06Q 30/0269; G06Q 50/01
USPC 705/14.51

(57) ABSTRACT

A system for creating and providing custom post-checkout out offers to a user is described. The system collects purchase history data and social network data associated with the user to create custom post-checkout offers for the user, which are provided to the user immediately after the user makes a purchase. The post-checkout offers may also be customized based on the products and/or services that were just purchased by the user.

### CLAIM OF PRIORITY

This application claims the benefit of priority under 35 U.S.C. §119(e) to the filing date of U.S. Provisional Patent Application No. 61/786,052, filed Mar. 14, 2013, entitled, “Post-Checkout Offer Systems and Related Methods,” which is incorporated herein by reference in its entirety.

### BACKGROUND

Internet users are exposed, on a daily basis, to a multitude of online advertisements. While such advertisements may be helpful in marketing products or services to the users, the advertisements may not reach the users when they are actually interested in purchasing the relevant goods or services.

Various embodiments of the present systems and methods recognize and address the foregoing considerations.

### SUMMARY

Generally, in various embodiments, a computer system includes at least one processor and is configured for: 1) receiving social network data associated with a user; 2) receiving an indication of a recent purchase substantially completed by the user on an e-commerce site; 3) receiving data associated with the recent purchase; 4) determining an appropriate offer for the user based at least in part on the social network data and the data regarding the recent purchase; and 5) conveying the offer to a client device associated with the user.

According to particular embodiments, a non-transitory computer-readable medium stores computer executable instructions for: 1) collecting purchase history data including data associated with at least one purchase made by a user; 2) sending the purchase history data to one or more remote computers; 3) detecting the user has made a purchase on a website associated with a retailer; 4) requesting a post-checkout offer that is at least partially based on the at least one purchase from the one or more remote computers; 5) receiving the post-checkout offer from the one or more remote computers; and 6) displaying the post-checkout offer to the user.

### BRIEF DESCRIPTION OF THE DRAWINGS

Reference will now be made to the accompanying drawings, which are not necessarily drawn to scale, and wherein:

FIG. 1 is a block diagram of a Post-Checkout Offer System according to one embodiment;

FIG. 2 is a block diagram of an exemplary Logistics Server of FIG. 1;

FIG. 3 shows a flow diagram that generally illustrates various steps executed by the exemplary Data Analysis and Post-Checkout Offer Module in FIG. 2 in accordance with various embodiments of the system of FIG. 1; and

FIGS. 4A and 4B depict screenshots and descriptions of various aspects and embodiments of the exemplary Data Analysis and Post-Checkout Offer Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, is configured to provide users with post-checkout offers. The computer system: 1) receives social network data and purchase history data associated with a user and data associated with a recent purchase made by the user; 2) based on the received data, determines an appropriate post-checkout offer for the user; and 3) conveys the post-checkout offer to the user. By presenting a post-checkout offer following a purchase by the user, the system may provide an offer at a time when the user is more likely to make additional purchases.

For example, the system receives social network data associated with a particular user of the system that includes information about the particular user's likes and dislikes as indicated on the social network. The system also receives data associated with previous purchases made by the particular user. Continuing with this example, the user makes a purchase on a particular online retailer's website. Shortly after checking out, the system is notified of the checkout by the retailer's servers. In this example, once the system receives the notice, the system determines (e.g., creates) an appropriate post-checkout offer based on the received social network data, purchase history data, and data associated with the purchase just made by the user. The system then sends the post-checkout offer to a computing device associated with the user.

A post-checkout offer may be for any appropriate product or service. In a particular embodiment, the post-checkout offer may be for one or more accessories for use with one or more items that the user has just purchased. In further embodiments, the post-checkout offer may be for one or more services related to one or more items that the user has just purchased. In other embodiments, the post-checkout offer may be for one or more items or services that are unrelated to the user's initial purchase.

The system may provide a post-checkout offer to the user through any of a variety of mechanisms. In various embodiments, the system provides the post-checkout offer in the form of a pop-up advertisement, or in any other suitable format. In other embodiments, the system provides post-checkout offers in combination with a retailer's website.

The system may be provided in any of a variety of ways by any appropriate entity. In various embodiments, the system may be provided by a logistics company or any other suitable company that has access to the user's consumer data. Additionally, the system may be implemented, at least in part, on a user's computing device (laptop computer, desktop computer, mobile device, etc.), on a company's servers, a social network server, a third party server (e.g., a retailer's server), and/or or any combination thereof.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, a smart mobile device, or other programmable data processing apparatus to produce a machine. As such, the instructions which execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Post-Checkout Offer System 10 according to a particular embodiment. As may be understood from this figure, the Post-Checkout Offer System 10 may include one or more Computer Networks 15, a Logistics Server 25, one or more Third Party Servers 35 (e.g., a web hosting server, retailer's server, any other server that hosts websites), a Social Network Server 45 (e.g., a sever associated with a social network), and one or more of the following: (1) a Mobile Computing Device 12 (e.g., a handheld computing device, a laptop computer, a tablet computer, or any other mobile computing device); and (2) a Desktop Computer 14.

The one or more Networks 15 facilitate communication between the Mobile Computing

Device 12, Desktop Computer 14, Logistics Server 25, Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, the communication link between the Mobile Computing Device 12, the Desktop Computer 14, the Logistics Server 25, the one or more Third Party Servers 35, and/or the Social Network Server 45 may be implemented via the Internet using Internet Protocol (IP).

It should be understood that the Servers 25, 35, and 45 do not necessarily need to be deployed over the network. For example, in various embodiments, any or all of Severs 25, 35, and 45 may be deployed locally on the user's computer, tablet, and/or mobile device.

FIG. 2 shows a block diagram of an exemplary embodiment of an exemplary Logistics Server 25 that is configured for executing a Data Analysis and Post-Checkout Offer Module 300. It should be understood based on this disclosure that any suitable computers (e.g., any of the computing devices shown in FIG. 1) may be used to execute this module and that various steps executed by the module may be executed on different computers.

The Logistics Server 25 may include several basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD Rom drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and a Data Analysis and Post-Checkout Offer Module 300. For simplicity and brevity, these modules are merely exemplary and may represent a number of program modules which control certain aspects of the operation of the Logistics Server 25 with the assistance of the Processor 60 and the Operating System 80. Exemplary embodiments of the Data Analysis and Post-Checkout Offer Module 300 are described in more detail below.

### Exemplary Data Analysis and Post-Checkout Offer Module

As shown in FIG. 2, certain embodiments of the Data Analysis and Post-Checkout Offer Module 300 are configured to gather and utilize consumer data to provide user-tailored post-checkout offers. The Data Analysis and Post-Checkout Offer Module 300 may operate alone or in combination with the Operating System 80 to perform that functions show in FIG. 3. It should be understood by one skilled in the art that certain embodiments of the Data Analysis and Post-Checkout Offer Module 300 may perform the functions shown in FIG. 3 in an order other than the order shown in FIG. 3. It should also be understood that various systems, when executing the Data Analysis and Post-Checkout Offer Module 300, may omit particular functions or execute additional functions in performing the functions of the Data Analysis and Post-Checkout Offer Module 300.

### Exemplary Embodiment of the Data Analysis and Post-Checkout Offer Module

Beginning at Step 302, the system receives social network data that is associated with the user. In various embodiments, the system is configured to receive the social network data directly from one or more servers associated with a particular online social network (e.g., Facebook®). In a particular embodiment, the system is configured to receive the social network data from the online social network via an application programming interface (API). In further embodiments, the system is configured to receive the social network data via an application that is integrated into the social network (e.g., a plug-in to the social network). In still further embodiments the system is configured to receive the social network data from one or more servers associated with the social network (e.g., the system is configured to receive the social network data that is transmitted from one or more social network servers to the system).

According to particular embodiments, the system is configured to receive the social network data from a web browser, web browser add-on, and/or any other suitable source. In a particular example, the system is configured to receive the social network from a web browser add-on, which is configured to collect the social network data at least partially in response to the user accessing the social network (e.g., the browser add-on scans a webpage associated with the social network when the user accesses the social network).

The social network data may include any of a variety of different types of information. In various embodiments, the social network data may include: (1) likes and dislikes that the user has indicated on the online social network (e.g., the user indicates they like one or more products or retailers, such as Nike®); (2) information associated with one or more advertisements that the user has selected (e.g., clicked on) displayed to the user on the social network; (3) the age of the user; (4) the gender of the user; (5) the religious affiliation of the user; (6) the political party of the user; (7) contact information (e.g., address, telephone number, email address, etc.) of the user; (8) the relationship status of the user (e.g., “in a relationship,” “single,” etc.); (9) previous places the user has lived; (10) the current address of the user; (11) the names of schools that the user currently attends or has attended in the past; (12) the profession of the user; and/or (13) past and/or current employment information associated with the user (e.g., one or more companies the user works for).

At Step 304, the system receives purchase history data associated with the user. The system may be configured to receive the purchase history data in one or more suitable ways. According to some embodiments, the system is configured to receive the purchase history data directly from one or more online retailers (e.g., the one or more Third Party Servers 35). In a particular embodiment, the system is configured to receive the purchase history data from the one or more retailers by accessing the data of the one or more retailers through one or more APIs.

In various embodiments, the system is configured to receive the purchase history data from a web browser or web browser add-on or from any other suitable source. In a particular embodiment, the system is configured to receive the purchase history data from a browser plug-in, which collects the purchase history data when a user makes a purchase from one or more online retailers (e.g., the browser scans the webpage associated with the online retailer). In further embodiments, the system is configured to receive the purchase history data from one or more third parties (e.g., the system receives the purchase history data from a party other than the online retailer).

The purchase history data may include one or more suitable types of data. In some embodiments, the purchase history data includes the date of one or more particular purchases and/or a listing of the one or more items purchased. In further embodiments, the purchase history data includes the payment method used by the user to pay for the purchase (e.g., credit card, debit card, etc.), and/or the method of shipping used to ship the purchased item to the customer (e.g., the carrier used to ship one or more parcels containing the one or more items purchase and/or the shipping product used, such as “Ground Shipping,” “Next Day Air,” etc.). In still further embodiments, the purchase history data includes the general type of the one or more items purchased (e.g., the category of the one or items, such as “shoes,” etc.), the price of the one or more purchased items, and/or any other information associated with the purchase.

At Step 306, the system receives an indication of a recent purchase from an online retailer substantially completed by the user on a website. The system may be configured to receive the indication of the recent purchase in any suitable way. In various embodiments, the system is configured to receive the indication of the recent purchase in the same way (or other ways) the system is configured to receive the social network data (at Step 302) and/or the purchase history data (at Step 304).

The system, according to various embodiments, is configured to receive the indication of the recent purchase substantially at the time the purchase is completed. In a particular embodiment, the system is configured to receive the indication of the recent purchase when the user selects a user-selectable indicium indicating submitting payment to the online retailer for the one or items (or services) of the purchase. In further embodiments, the system is configured to receive the indication of the recent purchase when the user receives a purchase confirmation email (e.g., containing an electronic receipt of the purchase).

The indication of the recent purchase, in various embodiments, includes purchasing data associated with the recent purchase. In a particular embodiment, the purchasing data associated with the recent purchase includes data that is substantially similar to the purchase history data described above at Step 304. According to a specific embodiment, the purchasing data associated with the recent purchase includes the one or more items purchased, the retailer from which the user purchased the one or items, the method of payment used by the user to purchase the one or more items, one or more descriptions of the one or more items, and the price paid for the one or more items.

According to various embodiments, after the system receives the purchasing data associated with the recent purchase, the system is configured to add the purchasing data associated with the recent purchase to the purchasing history data (described in Step 304). In further embodiments, the system is configured to save the purchasing data associated with the recent purchase.

The user may substantially complete the recent purchase from any suitable website. In various embodiments, the website is a checkout webpage associated with an online retailer (e.g., Amazon®). In further embodiments, the website is a third-party website associated with the online retailer for facilitating purchases by the user from the online retailer (e.g., eBay®, PayPal®, etc.). In still further embodiments, the website is a mobile website, or, for example, a website that is part of an application on a mobile device.

In a preferred embodiment, the website is associated with an online retailer; however, the website may be any suitable website that enables the user to make a purchase. In various embodiments, the webpage is associated with an online service, such as a website that is configured to aggregate flight search results (e.g., the system selects preferred flight options and/or fills in the user's shipping address).

Continuing to Step 308, the system determines an appropriate offer for the user based at least on in part on the received purchase history and social network data. In various embodiments, the system is configured to determine the appropriate offer for the user by matching the received data with the social network data as discussed in Steps 302 and 304. In particular embodiments, the system is configured to determine an appropriate offer for the user by determining particular items/products the user may like based at least in part on the saved received data.

The offer may be any appropriate offer. In various embodiments, the offer is for one or items related to the one or more items the user has purchased in the recent purchase of Step 306 (e.g., the offer is for one or more items that are accessories of the one or more items the user purchased in the recent purchase). In further embodiments, the offer is for one or more items that are unrelated to the one or more items of the recent purchase, but that are related to the saved received data. In still further embodiments, the offer is for one or more other items and/or services that are unrelated to the saved received data and/or the one or more items (or services) of the recent purchases.

In various embodiments, a post-checkout offer may be in any suitable form and may include one or more discounts on one or more items or services that are included in the offer and/or shipping charges associated with shipping the resulting order to the user. In various embodiments, the offer is an offer for accessories of the one or more products associated with the recent purchase (e.g., the recent purchase is for shoes and the offer is for shoe strings). In further embodiments, the offer is an offer for a service and/or a discount on a service, where the service may or may not be associated with the recent purchase. In still further embodiments, the offer may be for products unrelated to the recent purchase.

The system may be configured to determine the appropriate offer for the user based on data and/or information other than, or in addition to, the saved received purchase history and the social network data. In various embodiments, the system is configured to determine the appropriate offer based at least in part on retailer data associated with one or more retailers, which may be received by the system. In some embodiments, the system may be configured to determine the appropriate offer for the user based at least in part on other data such as data associated with characteristics of the user. As a particular example, the other data may be data that indicates that other users around the same age as the user typically like certain products (e.g., users ages 18-25 prefer products X, Y, and Z and the user is 19 years old, therefore, the system determines the user may prefer product X, Y, and/or Z).

At Step 310, the system conveys the appropriate offer to the user. The system may be configured to convey the appropriate offer to the user in any suitable way. In various embodiments, the system is configured to convey the appropriate offer to the user via a pop-up type webpage (e.g., as soon as the user completes the online purchase from the online retailer). In particular embodiments, the system is configured to convey the appropriate offer to the user via an electronic message, such as an email, message associated with a social network (e.g., a message on Facebook®), SMS message, and/or a message via another online service (e.g., a message on UPS MyChoice).

### Brief Example of the Exemplary Embodiment Shown in FIG. 3

In a preferred embodiment, the system is configured to convey the appropriate offer at least partially in response to the user completing a checkout process associated with an online retailer (e.g., the recent purchase discussed in Step 306). In a particular example, the user makes a purchase for one or more items from an online retailer. Continuing with this example, after the user selects the one or more items for purchase, the user completes the checkout process by entering in payment, shipment, and personal information (e.g., email address, account information, etc.).

The user then completes the purchase, in various embodiments, by selecting a button (e.g., a user-selectable indicium) confirming the purchase and the information input by the user. The system is configured, in this example, to receive an indication of the purchase the user has just made along with information associated with the purchase (e.g., the one or more items of the purchase, the price of the one or more items, etc. as discussed in Step 306). The system is configured to determine an appropriate offer for the user at least partially based on receiving the indication of the purchase. The system, in a preferred embodiment, is configured to convey the appropriate offer to the user by sending the appropriate offer to a client device associated with the user, which displays the appropriate offer in the form of a pop-up window.

### Alternate Embodiments

Alternative embodiments of the system may comprise features that are, in some respects, similar to the various components described above. Selected distinguishing features of these alternative embodiments are discussed below.

### Post-Checkout Offers May Be Based on One or More Preferences of the User

In various embodiments, the system may be configured to convey a post-checkout offer (e.g., at Step 310), wherein the one or more items or services of the post-checkout offer are at least partially based on one or more preferences of the user. The one or more preferences of the user may be any suitable preferences including, but not limited to: 1) product and/or service types (e.g., running shoes); 2) certain brands (e.g., the user prefers Nike® shoes); 3) specific attributes of products and/or services (e.g., the user prefers only black shoes, the user prefers only shoes with laces, the user prefers online shoe sellers, the user wears a certain size shoe, etc.) and/or 4) any combination of one or more preferences of the user (e.g., the user prefers black Nike® running shoes).

Continuing with this example, the system may be configured to receive the one or more preferences of the user in one or more suitable ways. In a particular embodiment, the system is configured to enable the user to indicate the one or more preferences (e.g., the user indicates they prefer Nike® shoes). In another embodiment, the system is configured to receive the one or more preferences of the user via social network data, as received, for example, in Step 302 above (e.g., the user has indicated on a social network that they are male, so the system receives the social network data indicating the user is male and modifies the search term from “shoes” to “men's shoes”).

### Preferences Used to Determine Post-Checkout Offers May Be Displayed to the User

In various embodiments, the system is configured to display the one or more preferences of the user. In a particular embodiment, the system is configured to display the one or more preferences of the user with the post-checkout offer. In further embodiments, the system is configured to display the one or more preferences of the user in a browser window separate from the post-checkout offer. In still further embodiments, the system is configured to display the one or more preferences of the user in a pop-up style window and/or any other suitable way.

According to particular embodiments, the system is configured to enable the user to modify the one or more preferences of the user in any suitable way and by any suitable mechanism. In various embodiments, the system enables the user to modify the one or more preferences of the user on a search results webpage (e.g., when search results are displayed to the user). In other embodiments, the system is configured to enable the user to modify the one or more preferences of the user on a social network, on a logistics provider's website, through a web browser add-on, within the post-checkout offer, etc.

### The Post-Checkout Offer(s) May Be For One or More Offers

In another example, the system is configured to, in various embodiments, convey the post-checkout offer (e.g., at Step 310) to the user, wherein the post-checkout offer is for one or more offers from two or more separate retailers and/or services providers (e.g., the post-checkout offer is for an offer from Disney® and Toys R Us®). In a particular embodiment, the one or more offers from two or more separate retailers are for products that are similar (e.g., the retailers compete for purchases for similar items). In other embodiments, the one or more offers from two or more separate retailers are for unrelated products (e.g., the post-checkout offer is for a vacation package and a children's toy).

In further embodiments, the two or more separate retailers and/or service providers share revenue when the user clicks on one offer and/or posts a message about a purchase, wherein the message references the two or more separate retailers, on a social network. In a particular example, the post-checkout offer includes offers from Disney® and Toys R Us®. In this example, the user selects (e.g., clicks) on the Disney® offer and makes a purchase. In various embodiments, Toys R Us® may share some of the revenue from the purchase the user makes after clicking on the Disney® offer.

In various embodiments, after the user selects the Disney® offer, the user, in this example, posts information about the purchase on a social network associated with the user, wherein the post shows both Disney® and Toys R Us®. In various embodiments, continuing with this example, Disney® may share profits with Toys R Us® and/or Toys R Us® may share profits with Disney® if, for example, a second user clicks on the social network post made by the first user and then makes a purchase from Toys R Us®.

### Post-Checkout Offers May Be Conveyed in Any Suitable Way

In various embodiments, the system may be configured to send the post-checkout offer in response to a request from the user. In this embodiment, the system is configured to receive the request for the post-checkout offer in any suitable way. The system may be configured to, for example, receive the request from a web browser, a browser add-on, or any other suitable source. According to a particular embodiment, the system is configured to receive the request in response to a selection by the user of a user-selectable indicium.

In a particular embodiment, the request includes details about an item or service that the user has just purchased. In various embodiments, the request includes certain information or items to be included in or excluded from the post-checkout offer. In a particular example, the system may receive a request for a post-checkout offer for items selected from a list included with the request.

### Exemplary User Experience

FIGS. 4A and 4B depict screenshots of exemplary embodiments of the System 10. First, the left-side portion of FIG. 4A shows a web page that the system has modified to include a user-selectable indicium that the user may select to receive a post-checkout offer. The right-side portion of FIG. 4A shows a post-checkout offer for a premium logistics service that the system may display in response to the user selecting the user-selectable indicium.

Turning to FIG. 4B, in this figure, the left-side portion shows a web page that the system has modified to include a user-selectable indicium that the user may select to receive a post-checkout offer. The right-side portion of FIG. 4B shows a post-checkout offer for multiple products and services (offered by multiple different sources) that the system may display in response to the user selecting the user-selectable indicium. The offer may be tailored to the user's interests based, for example, on the user's current purchase and/or on data associated with an on-line social network account associated with the user.

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer system comprising:
at least one processor, wherein said computer system is configured for:
(A) receiving social network data associated with a user;
(B) receiving an indication of a recent purchase substantially completed by the user on an e-commerce site;
(C) receiving data associated with the recent purchase;
(D) determining an appropriate offer for the user based at least in part on the social network data and the data regarding the recent purchase; and
(E) conveying the offer to a client device associated with the user.

2. The computer system of claim 1, wherein:
(A) the social network data comprises one or more products the user has indicated on the social network; and
(B) the data associated with the recent purchase comprises data associated with one or more products purchased by the user.

3. The computer system of claim 2, wherein the computer system is further configured for receiving one or more preferences of the user.

4. The computer system of claim 3, wherein determining the appropriate offer for the user based at least in part on the social network data and the data regarding the recent purchase comprises determining an appropriate offer for the user at least partially based on the received one or more preferences of the user.

5. The computer system of claim 4, wherein the system is further configured for enabling the user to modify the received one or more preferences of the user.

6. The computer system of claim 3, wherein:
(A) the computer system is further configured for receiving purchase history data associated with the user, wherein the purchase history data associated with the user comprises data associated with one or more purchases made by the user in the past; and
(B) the one or more preferences of the user further comprise the purchase history data associated with the user.

7. The computer system of claim 6, wherein receiving the purchasing data associated with the user comprises receiving the purchasing data from one or more retailer servers.

8. A computer system for providing one or more post-checkout offers to a user, said computer system comprising:
(A) receiving purchase history data, wherein the purchase history data comprises data associated with at least one purchase associated with a user;
(B) receiving social network data associated with the user;
(C) receiving an indication of, and data associated with, an immediate purchase by the user on a website associated with a particular retailer;
(D) determining one or more post-checkout offers based on data selected from a group consisting of:
i. the purchase history data;
ii. the social network data; and
iii. the data associated with the immediate purchase; and
(E) at least partially in response to receiving the indication of the immediate purchase, transmitting the one or more post-checkout offers to the user.

9. The computer system of claim 8, wherein determining the one or more post-checkout offers comprises determining the one or more post-checkout offers at least partially based on the purchase history data.

10. The computer system of claim 9, wherein the one or more post-checkout offers comprise at least two offers.

11. The computer system of claim 10, wherein the at least two offers comprise at least one offer from a first retailer of a plurality of retailers and at least one offer from a second retailer of the plurality of retailers.

12. The computer system of claim 9, wherein the immediate purchase comprises a purchase of one or more products from a plurality of retailers, wherein the purchase of one or more products from the plurality of retailers occurred within the previous twenty-four hours.

13. The computer system of claim 9, wherein determining the one or more post-checkout offers comprises creating one or more post-checkout offers associated with:
(A) a plurality of retailers; and
(B) the social network data.

14. The computer system of claim 8, wherein the immediate purchase comprises one or more products.

15. The computer system of claim 14, wherein the one or more post-checkout offers comprise an accessory of the one or more products of the immediate purchase.

16. The computer system of claim 14, wherein the one or more post-checkout offers comprise a product substantially similar to the one or more products of the immediate purchase.

17. The computer system of claim 14, wherein the one or more post-checkout offers comprise a service associated with the one or more products of the immediate purchase.

18. The computer system of claim 8, wherein receiving the purchase history data comprises receiving the purchase history data from a web browser add-on configured to collect purchasing data associated with the user.

19. The computer system of claim 18, wherein the web browser add-on is associated with a logistics company.

20. A non-transitory computer-readable medium storing computer executable instructions for:
(A) collecting purchase history data, wherein the purchase history data comprises data associated with at least one purchase made by a user;
(B) sending the purchase history data to one or more remote computers;
(C) detecting the user has made a purchase on a website associated with a retailer;
(D) requesting a post-checkout offer from the one or more remote computers, wherein the post-checkout offer is at least partially based on the at least one purchase;
(E) receiving the post-checkout offer from the one or more remote computers; and
(F) displaying the post-checkout offer to the user.

21. The non-transitory computer-readable medium of claim 20, wherein displaying the post-checkout offer to the user comprises displaying the post-checkout offer via a mechanism selected from a group consisting of:
(A) a pop-up window;
(B) a social network message;
(C) an SMS message; and
(D) an email.

22. The non-transitory computer-readable medium of claim 21, wherein the one or more remote computers are associated with a logistics company.

23. The non-transitory computer-readable medium of claim 20, wherein detecting the user has made the purchase on the website associated with the retailer comprises detecting the user has made the purchase via a browser add-on.

24. The non-transitory computer-readable medium of claim 23, wherein detecting the user has made the purchase on the website associated with the retailer further comprises detecting the user has made the purchase substantially immediately after the at least one purchase.
